(19) United States
(12) Patent Application Publication
(10) Pub. No.: US 2007/0229548 A1
(43) Pub. Date: Oct. 4, 2007

(54) Method and image processing device for improved pictorial representation of images with different contrast

(76) Inventor: Bernhard Kidalka, Gunzendorf (DE)

Correspondence Address: HARNESS, DICKEY & PIERCE, P.L.C., P.O.BOX 8910, RESTON, VA, 20195, US

(21) Appl. No.: 11/727,937

(22) Filed: Mar. 29, 2007

(30) Foreign Application Priority Data
Mar. 30, 2006 (DE) 10 2006 014 903.3

(51) Int. Cl. G09G 5/00

(52) U.S. Cl. 345/653

(57) ABSTRACT

A method and an image processing device are disclosed for improved or even optimized pictorial representation of images with different contrast. In the case of at least one embodiment of the method, a 3D pictorial representation is generated from two 2D image data records, which represent images of the same object area with different contrast, by projecting the image of the first 2D image data record into a X-Z plane of a 3D space of the 3D pictorial representation, while preserving the gray-scale values of the image, by generating for each pixel of the first 2D image data record from a gray scale value of a corresponding pixel of the second 2D image data record a height value that represents this gray scale value, and displaying it as assigned Y-value of the projected image in the 3D display. In at least one embodiment, the time for the evaluation of images can be shortened, and the sensitivity in the visualization of abnormalities in the images can be raised with the aid of at least one embodiment of the method and/or the image processing device.

### PRIORITY STATEMENT

The present application hereby claims priority under 35 U.S.C. §119 on German patent application numbers DE 10 2006 014 903.3 filed Mar. 30, 2006, the entire contents of which is hereby incorporated herein by reference.

### FIELD

Embodiments of the present application generally relate to a method and/or an image processing device, such as one for improved or even optimized pictorial representation of images of the same object area and with different contrast, for example, in particular in medical imaging.

### BACKGROUND

It is required in some instances in the field of medical imaging to record images of the same object area of a patient with different recording parameters in order to be able to detect different details of the images. Thus, when a patient is being examined with the aid of a magnetic resonance tomography many images can be generated as a function of the examined body region. The same slices are in this case often recorded with a T1 weighting and with a T2 weighting. The tomograms of the same body area obtained in this way with different contrast can then be used by the doctor as basis for a diagnosis. A comparable mode of procedure is also selected in the case of other imaging methods in medical imaging, for example in the field of computed tomography.

Depending on the type of examination, for example in the case of whole body screening, the quantity of data to be sifted can be very large, and the sifting of the individual data may therefore require a great deal of time. When examining 2D images, it is very often necessary in this case for the same anatomical slices with different contrast to be compared and evaluated. The search for the smallest abnormalities is therefore very time consuming and susceptible to error.

It is known for the purpose of mitigating these problems to provide the doctor with support by way of computer aided diagnosis (CAD). In this case, algorithms are applied to the 2D image data; they search the images automatically for salient features and highlight the stated features found for the user. The application of the algorithms is, however, likewise associated with a certain computing time and error rate.

### SUMMARY

In at least one embodiment of the present invention, a method and/or an image processing device is disclosed, that facilitates for the user the evaluation of 2D images of the same object area with different contrast.

In the proposed method of at least one embodiment, a 3D pictorial representation is generated from two 2D image data records which represent images of the same object area with different contrast, and displayed to the user. To this end, the image of the first 2D image data record is projected into an X-Z plane of the 3D space of the 3D pictorial representation while preserving the gray scale values of the image, and by generating for each pixel of the first 2D image data record from a gray scale value of a corresponding pixel of the second 2D image data record a height value that represents this gray scale value, and displaying it as assigned Y-value of the projected image in the 3D display. This projection or assignment produces a three-dimensional visual display that unites the two contrast information items in an image, and brings very small abnormalities to bear more strongly by way of the 3D effect. This yields a saving in time for the user in evaluation of the 2D images, and a raised sensitivity in the visualization of abnormalities.

The method and/or the associated image processing device of at least one embodiment are suitable thereby for all imaging methods in the case of which two images of the same object area and with different contrast are acquired. The method and the image processing device of at least one embodiment can therefore also be used, if required, outside imaging medical technology.

The generation of a height value representing the gray scale value is preferably performed in such a way that a height value that is proportional to the gray scale value is generated. Of course, however, it is also possible, if required, to use nonlinear transformations that lead to stretching or compression of specific gray scale value ranges upon conversion into height values.

The image processing device of at least one embodiment for carrying out the method of at least one embodiment includes an imaging module which is designed such that it generates a 3D pictorial representation from two 2D image data records that represent images of the same object area with different contrast, doing so by projecting the image of the first 2D image data record into an X-Z plane of the 3D space of the 3D pictorial representation while preserving the gray scale values of the image, and by generating for each pixel of the first 2D image data record from a gray scale value of a corresponding pixel of the second 2D image data record a height value that represents this gray scale value, and displaying it as assigned Y-value of the projected image in the 3D display. The illustrated 3D image can, of course, be interactively rotated, zoomed and displaced. The imaging device is preferably implemented in this case in an image computer, for example a magnetic resonance tomograph or a computer tomograph.

### BRIEF DESCRIPTION OF THE DRAWINGS

An example embodiment of the present method and the associated image processing device are explained briefly once more below in conjunction with the drawings, in which:

FIG. 1 shows an example of two 2D images of an object area with different contrast; and

FIG. 2 shows an example of a 3D pictorial representation of the two images in accordance with an embodiment of the present method.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described. Like numbers refer to like elements throughout. As used herein, the term “and/or” includes any and all combinations of one or more of the associated listed items.

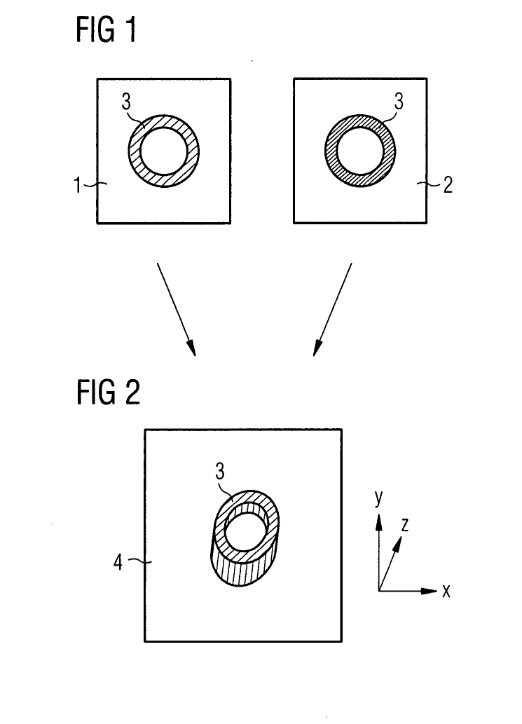

FIG. 1 illustrates an example embodiment of the two images of the same object area with different contrast. Only an annular structure 3 was used in this case, for the purpose of simplification. The contrast in the left-hand image is less than the contrast in the right-hand image, as is indicated by the different hatching. What is involved here is tomograms such as are obtained, for example, in the case of magnetic resonance imaging with different weighting. The left-hand image can, for example, represent a T1-weighted image 1, and the right-hand image a T2-weighted image 2.

With the aid of an example embodiment of the present method, the different 2D information items are interlinked by means of a 2D after a 3D projection, and are visualized in three dimensions as a result. Here, a three-dimensional visualization can be understood both as a display on a 3D monitor, and as a display, appropriately causing a three-dimensional pictorial impression, on a 2D monitor.

The T1-weighted image 1 in the 3D space of pictorial representation is tilted or projected into the X-Z plane in the image processing module of the image processing device of an example embodiment of the present invention, which reads in the 2D image data records of the two images, the gray-scale values of the image being preserved. Here, the 3D space includes three axes X, Y and Z of a Cartesian coordinate system in the case of which the Y-axis corresponds to a height axis in the pictorial representation.

In addition, for each individual pixel of the projected T1-weighted image 1 and item of height information is calculated starting from the T2-weighted image 2 at the same anatomical slice position, and is displayed in the Y-direction. This projection produces a three-dimensional relief display of the structure 3, as can be detected in the 3D pictorial representation 4 on a monitor. The pixels (xᵢ, yᵢ) of the T1-weighted image 1 are therefore converted into 3D pixels (Xᵢ, Zᵢ, Yᵢ) of the 3D pictorial representation, xᵢ becoming Xᵢ and yᵢ becoming Zᵢ, and Yᵢ being calculated from the gray scale value of the T2-weighted image 2 at the respective same image position xᵢ, yᵢ. The pictorial representation of the 3D pixels (Xᵢ, Zᵢ, Yᵢ) then takes place with the aid of the gray scale value of the T1-weighted image 1. The gray scale values of the T1-weighted image 1 are thereby retained unchanged while the contrast information from the T2-weighted image 2 can be detected from the height of the structure 3 in the relief display.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for generating a 3D pictorial representation from at least two 2D image data records which represent images of an object area with different contrast, comprising:
projecting an image of a first 2D image data record into an X-Z plane of a 3D space of the 3D pictorial representation, while preserving gray-scale values of the image;
generating from a gray scale value of a corresponding pixel of a second 2D image data record, for each pixel of the first 2D image data record, a height value that represents the gray scale value; and
displaying the generated height values as assigned Y-values of the projected image in the 3D display, to generate the 3D pictorial representation.

2. The method as claimed in claim 1, wherein the generating includes generating, from the gray scale value of the corresponding pixel of the second 2D image data record, a height value, for each pixel of the first 2D image data record, that is proportional to the gray scale value.

3. The method as claimed in claim 1, wherein the second 2D image data record includes a relatively higher contrast than the first 2D image data record.

4. The method as claimed in claim 1, wherein the second 2D image data record includes a relatively lower contrast than the first 2D image data record.

5. The method as claimed in claim 1, wherein the first 2D image data record is at least one of a T1-weighted image data record and a T2-weighted image data record of a magnetic resonance tomography picture, and the second 2D image data record is at least one of a T1-weighted image data record and a T2-weighted image data record of a magnetic resonance tomography picture.

6. An image processing device for pictorial representation of images with different contrast, comprising:
a pictorial representation module to generate a 3D pictorial representation from two 2D image data records that represent images of the same object area with different contrast, the pictorial representation module being used to project the image of the first 2D image data record into an X-Z plane of a 3D space of the 3D pictorial representation while preserving gray scale values of the image, and to generate from a gray scale value of a corresponding pixel of the second 2D image data record, for each pixel of the first 2D image data record, a height value that represents this gray scale value, and to displaying the height values as assigned Y-values of the projected image in the 3D display.

7. The image processing device as claimed in claim 6, wherein the height values are height values that are proportional to the respective gray scale values.

8. The method as claimed in claim 1, wherein the method is for generating a 3D pictorial representation in medical imaging.

9. The method as claimed in claim 2, wherein the second 2D image data record includes a relatively higher contrast than the first 2D image data record.

10. The method as claimed in claim 2, wherein the second 2D image data record includes a relatively lower contrast than the first 2D image data record.

11. The method as claimed in claim 2, wherein the first 2D image data record is at least one of a T1-weighted image data record and a T2-weighted image data record of a magnetic resonance tomography picture, and the second 2D image data record is at least one of a T1-weighted image data record and a T2-weighted image data record of a magnetic resonance tomography picture.

12. A computer readable medium including program segments for, when executed on a computer device, causing the computer device to implement the method of claim 1.

13. An image processing device for generating a 3D pictorial representation from at least two 2D image data records which represent images of an object area with different contrast, comprising:
means for projecting an image of a first 2D image data record into an X-Z plane of a 3D space of the 3D pictorial representation, while preserving gray-scale values of the image;
means for generating from a gray scale value of a corresponding pixel of a second 2D image data record, for each pixel of the first 2D image data record, a height value that represents the gray scale value; and
means for displaying the generated height values as assigned Y-values of the projected image in the 3D display, to generate the 3D pictorial representation.

14. The image processing device as claimed in claim 13, wherein the means for generating includes generating, from the gray scale value of the corresponding pixel of the second 2D image data record, a height value, for each pixel of the first 2D image data record, that is proportional to the gray scale value.

15. The image processing device as claimed in claim 13, wherein the second 2D image data record includes a relatively higher contrast than the first 2D image data record.

16. The image processing device as claimed in claim 13, wherein the second 2D image data record includes a relatively lower contrast than the first 2D image data record.

17. The image processing device as claimed in claim 13, wherein the first 2D image data record is at least one of a T1-weighted image data record and a T2-weighted image data record of a magnetic resonance tomography picture, and the second 2D image data record is at least one of a T1-weighted image data record and a T2-weighted image data record of a magnetic resonance tomography picture.
